(19) United States
(12) Patent Application Publication
(10) Pub. No.: US 2006/0247037 A1
(43) Pub. Date: Nov. 2, 2006

(54) Advertising system and method for slot machine game using image ad symbols on the internet

(76) Inventor: Kyung Yang Park, Seoul (KR)

Correspondence Address: AKERMAN SENTERFITT, 801 PENNSYLVANIA AVENUE N.W., SUITE 600, WASHINGTON, DC, 20004, US

(21) Appl. No.: 10/563,757

(22) PCT Filed: Jul. 8, 2004
(86) PCT No.: PCT/KR04/01682

§ 371 Date: May 15, 2006

(30) Foreign Application Priority Data
Jul. 9, 2003 (KR) 10-2003-0046435
Jan. 5, 2004 (KR) 10-2004-0000326

(51) Int. Cl. A63F 13/00

(52) U.S. Cl. 463/29; 463/20; 463/42

(57) ABSTRACT

An Internet advertising system includes a service provider server which stores and manages advertising symbols transmitted from a number of advertising sponsors; an advertisement (or ad) generating server which generates advertising images from the advertising symbols provided from the service provider server; an ad selecting server which mixes an advertising image selected by a user among the various kinds of ads produced from the ad generating server; a slot machine game server which constitutes the advertising images mixed by the ad selecting server into a display screen of a slot machine game; and a user terminal which receives a slot machine game service.

### TECHNICAL FIELD

The present invention relates to an Internet advertising system and method for use in a slot machine game using image advertising symbols, and more particularly, to an Internet advertising system and method for use in a slot machine game in which display symbols such as marks of Watermelon, BAR and 777 used for a slot machine game on the Internet are replaced with particular company logos or image advertising symbols, to thereby make users enjoy playing the slot machine game and access advertising information, on the Internet.

### BACKGROUND ART

Advertising contents which are provided in an off-line reality are provided as they are for currently existing Internet advertising systems in the Internet virtual space. In particular, since banner ads which flow over on the Internet take on similar patterns usually, users are not nearly induced to be interested in the banner ads, but easily look away from the banner ads. Thus, a more attractive and effective Internet advertising system is needed.

### DISCLOSURE OF INVENTION

To solve the above problems, it is an object of the present invention to provide an Internet advertising system and method for use in a slot machine game in which display symbols such as marks of Watermelon, BAR and 777 used for a slot machine game on the Internet are replaced with particular company logos or image advertising symbols, to thereby make users enjoy playing the slot machine game and access various pieces of advertising information, on the Internet.

To accomplish the above object of the present invention, there is provided an Internet advertising system using image advertising symbols for use in a slot machine game, the Internet advertising system comprising: a service provider server which stores and manages advertising symbols transmitted from a number of advertising sponsors according to different advertising contract conditions; an advertisement (or ad) generating server which generates advertising images from the advertising symbols provided from the service provider server; an ad selecting server which mixes an advertising image selected by a user among the various kinds of ads produced from the ad generating server; a slot machine game server which constitutes the advertising images mixed by the ad selecting server into a display screen of a slot machine game; and a user computer with which the user registers for the service provider server as a member via the Internet and then receives a slot machine game service provided from the slot machine game server.

There is also provided an Internet advertising method using image advertising symbols for use in a slot machine game, the Internet advertising method comprising the steps of: (a) generating various kinds of advertising images according to different advertising contract conditions with respect to advertising sponsors and storing the same in a service provider server; (b) a user accessing the service provider server via the Internet and selecting a particular advertising image to be used for a slot machine game among the various kinds of displayed advertising images; (c) mixing the particular advertising image selected by the user in an advertisement (or ad) selecting server and constituting the advertising image into an initial screen of the slot machine game; and (d) the user depressing a spin button displayed on the initial screen of the slot machine game and starting to play the slot machine game.

### BRIEF DESCRIPTION OF DRAWINGS

The above and other objects and advantages of the present invention will become more apparent by describing the preferred embodiments thereof in detail with reference to the accompanying drawings in which:

FIG. 1 is a schematic view showing an Internet advertising system for a slot machine game using image ad symbols according to the present invention;

FIG. 2 is a detailed view showing the FIG. 1 system;

FIG. 3 is a view showing an example of constituting a category type initial screen of ads via the Internet;

FIG. 4 is a view showing an example of constituting a category type initial screen of ads via a cellular phone;

FIGS. 5 and 6 are a view showing an example of constituting a display type initial screen of ads, respectively;

FIGS. 7 and 8 are a view showing an example of a screen window showing an ad screen according to an advertising contract condition in an identical category, respectively;

FIG. 9 is a view showing an example of a start screen of a slot machine game;

FIG. 10 is a view showing an example of a screen window in a premium shopping mall website;

FIG. 11 is a view showing an example of a slot machine game screen according to the present invention;

FIG. 12 is a view showing another example of a slot machine game screen according to the present invention;

FIG. 13 is a view showing still another example of a slot machine game screen according to the present invention;

FIG. 14 is a view showing an example of a congratulating message screen to be displayed in the case that a first prize winner is decided in FIG. 13;

FIG. 15 is a view showing an example of a screen window for making a user decide whether or not a game will be continued and whether or not a new ad will be selected;

FIG. 16 is a view showing an example of a screen window for making a user select one between a category type ad menu and a display type ad menu;

FIG. 17 is a view showing an example of a screen window for making a user select a merchandise bond or a real product for a user selected product in a shopping mall;

FIG. 18 is a view showing an example of a screen window illustrating a merchandise bond transmitted to a user cellular phone;

FIG. 19 is a view showing an example of a screen window on which it is asked whether or not a user wants to receive his or her selected product at his or her designated address;

FIG. 20 is a view showing an example of a screen window which enables a user to confirm his or her address designated in FIG. 19;

FIG. 21 is a view showing an example of a screen window which enables a user to input a phone number of a person who receives a product selected by the user;

FIG. 22 is a view showing an example of a screen window which enables a user to transfer his or her cyber money to the other person;

FIG. 23 is a view showing an example of a screen window showing that the cyber money has been completely transferred to the other person in FIG. 22;

FIG. 24 is a view showing an example of an output screen of a cellular phone of the other person who has received the cyber money transferred from the transferrer;

FIG. 25 is a view showing an example of a screen window in the case that the phone number of a cellular phone of the other person who has received the cyber money transferred from the transferrer is newly registered;

FIG. 26 is a view showing an example of a screen window which enables a user to decide a winning ratio in an Internet advertising system for a slot machine game according to the present invention;

FIG. 27 is a view showing an example of a screen window which enables a user to decide whether or not a premium shopping mall will be accessed according to a result of a slot machine game according to the present invention; and

FIGS. 28 through 31 are flow chart views illustrating processes of an Internet advertising method for a slot machine game using image advertising symbols according to an embodiment of the present invention.

### BEST MODE FOR CARRYING OUT THE INVENTION

Preferred embodiments of the present invention will be described with reference to the accompanying drawings.

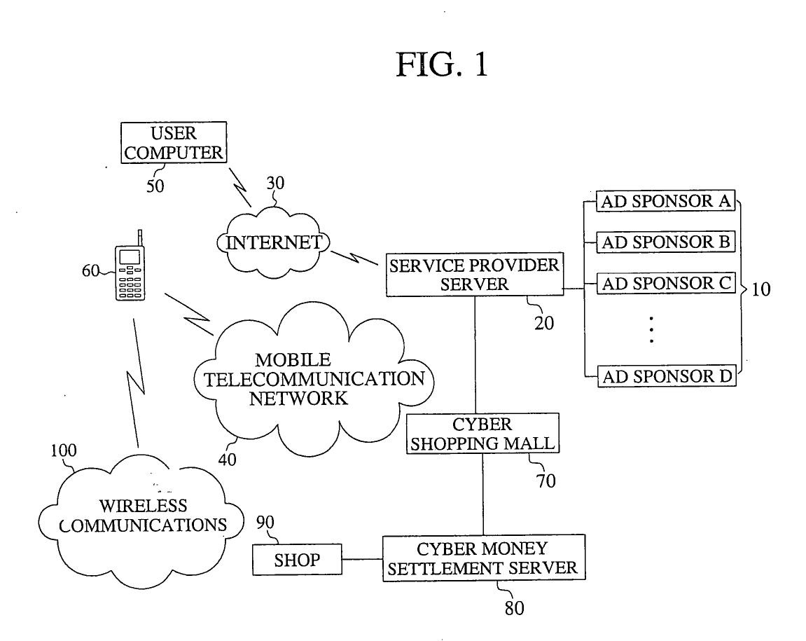

FIG. 1 is a schematic view showing an Internet advertising system for a slot machine game using image ad symbols according to the present invention. The Internet advertising system shown in FIG. 1 includes: a number of ad sponsors 10; a service provider server 20; a user computer/cellular phone 50 or 60 which can access the service provider server 20 via the Internet 30 or a mobile telecommunications network 40; a cyber shopping mall 70; a cyber money settlement system 80; shops 90; and a local area network (LAN) 100 which enables a user to access the shops 90 by the cellular phone 60.

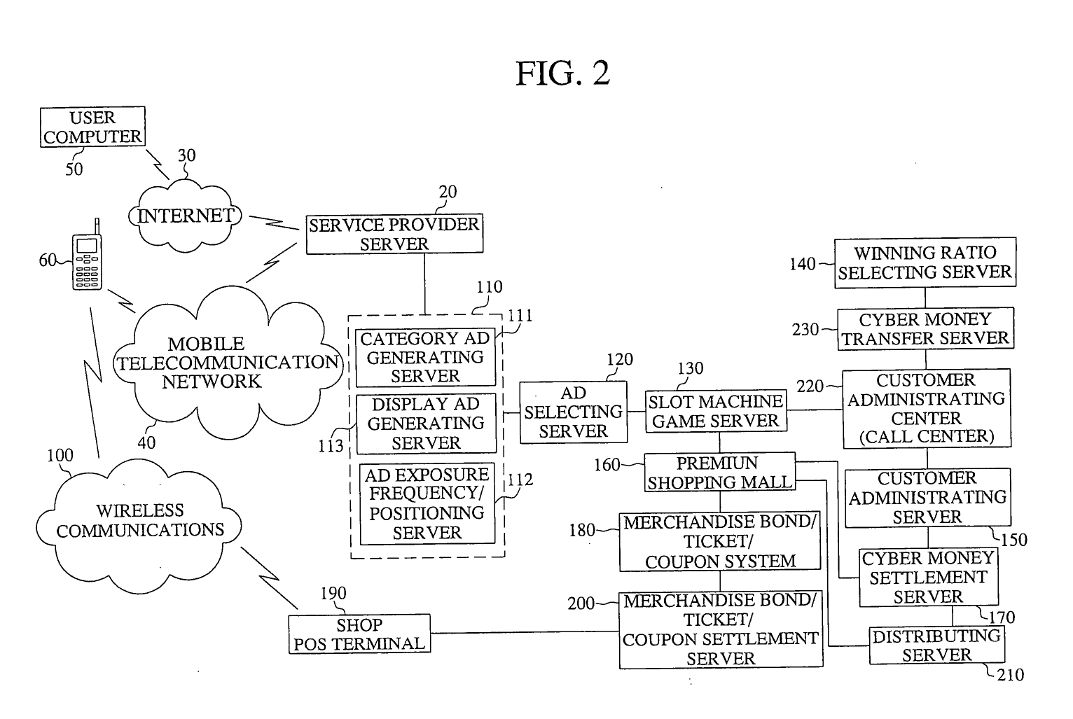

FIG. 2 is a detailed view showing the FIG. 1 system which shows the Internet advertising system for a slot machine game using image advertising symbols according to the present invention.

As shown in FIG. 2, the advertising system according to the present invention includes: a service provider server 20 which manages an advertising game service entirely; an ad generating server 110 which generates an advertising image based on an advertising image received from an advertising sponsor; a category type ad generating server 111 which separates the generated ads by a category classified according to an advertising content, and connects the category type ads with corresponding advertising images, respectively; an ad exposure frequency/positioning server 112 which designates an ad exposure frequency and position according to an advertising condition such as an amount and a premium; and a display type ad generating server 113 which exposes an ad according to the ad exposure frequency/positioning server 112, in which the category type ad generating server 111, the ad exposure frequency/positioning server 112, and the display type ad generating server 113 are a lower-part system of the ad generating server 110.

Also, the advertising system includes: an ad selecting server 120 which connects with a slot machine game in the case that a user selects an advertising image in an integration website where various advertising images generated in the ad generating server 110 having the above-described lower-part system; a slot machine game server 130 which constitutes an advertising image selected according to a user's ad selection into a display screen; a winning ratio selecting server 140 which enables a user to decide a game winning ratio; a customer management server 150 which manages membership information and cyber money information of the customers; a premium shopping mall 160 which provides a premium according to a result of a game; a cyber money settlement server 170 which settles cyber money according to results of the premium shopping and game; a merchandise bond/coupon/ticket system 180 which manages and delivers merchandise bonds, coupons and tickets according to the game results or premium shopping results; and the Internet 30 and a mobile telecommunications network 40 which connects the service provider server 20 with a user's computer/cellular phone 50 or 60 with which a game is played.

Also, the advertising system according to the present invention includes: a POS terminal 190 of each of shops such as department stores, movie theaters, restaurants, automobile agencies where users can use merchandise bonds, coupons and tickets; a LAN 100 which adopts bar code signals, infrared ray signals, radio frequency signals, or Bluetooth signals which enables a user to communicate with the POS terminal 190 by his or her cellular phone 60; a merchandise bond/coupon/ticket settlement server 200 which settles merchandise bond/coupon/ticket which a user has used in shops; a delivery system 210 which delivers a product selected by a user in the premium shopping mall 160 according to a user's request, via a delivery company; a customer management center which is called a call center 220 which grasps and handles delivery-related processing jobs and users' request and complaint; and a cyber money transfer server 230 which transfers cyber money to the other user according to user's request.

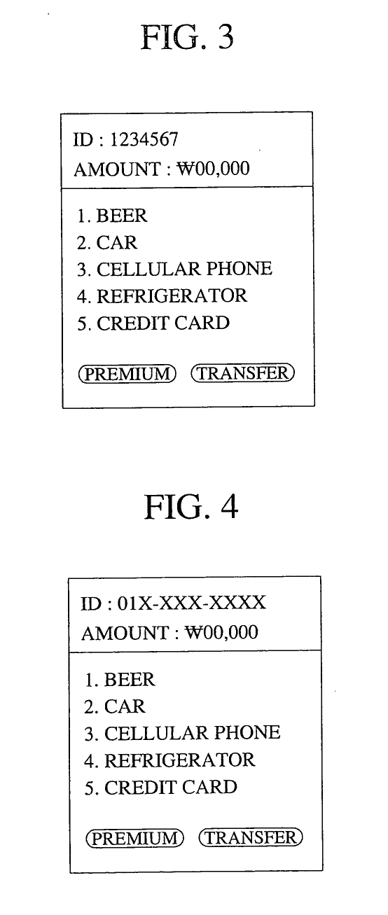

In order to provide an advertising service according to the present invention, if a service provider completes an advertising contract with an advertising agency or an advertising sponsor, registers the advertising contract content in the service provider server 20, and receives an advertising image from the advertising sponsor to then be stored in the service provider server 20, the ad generating server 110 prepares an exposure of an ad on a category type screen or a display type screen of ads as shown in FIGS. 3 through 6, in association with the category type ad generating server 111, the ad exposure frequency/positioning server 112, and the display type ad generating server 113 which are all the lower-part system of the ad generating server 110, according to advertising contract conditions such as an advertising fee, a frequency of exposing ads, and an exposure position on a screen, which are registered in the service provider server 20.

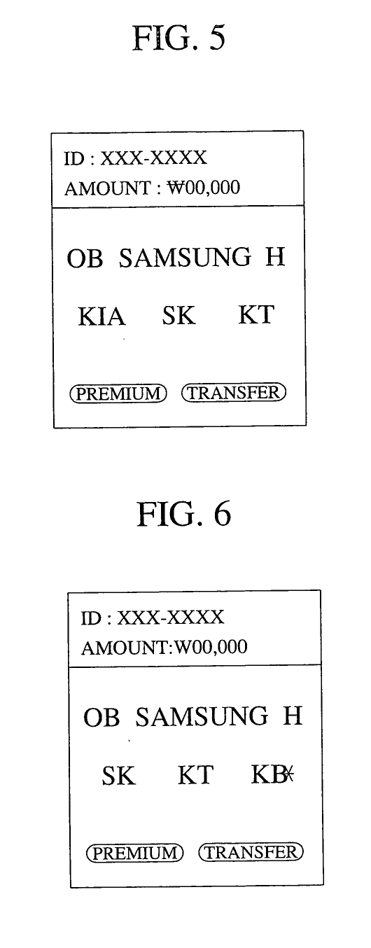

FIG. 3 is a view showing an example of constituting a category type initial screen of ads via the Internet. FIG. 4 is a view showing an example of constituting a category type initial screen of ads via a cellular phone. FIGS. 5 and 6 are a view showing an example of constituting a display type initial screen of ads, respectively.

As shown in FIGS. 3 and 4, a user's specific ID (identification) and an amount of cyber money are displayed in the upper portion of the category type initial screen of ads, in which each ID is 1234567 or 01X-XXX-XXXX, and each cyber money amount is z,900 οο,οοο, and categorized items where 1 is beer, 2 is automobiles, 3 is cellular phones, 4 is refrigerators, and 5 is credit cards, and a premium button and a transfer button are displayed in the lower portion thereof.

Also, as shown in FIGS. 5 and 6, a user's specific ID and an amount of cyber money are displayed in the upper portion of the display type initial screen of ads, in which each ID is XXX-XXXX and each cyber money amount is z,900 οο,οοο, and display items and a premium button and a transfer button are displayed in the lower portion thereof.

First, logos displayed on a logo selecting screen window of FIG. 5 are automatically selected according to an amount of an advertising fee among a number of logos stored in a database. For example, logos such as OB, SAMSUNG, H, KIA, SK and KT which are all logos of Korean enterprises are displayed on the screen window. In the case of a logo selecting screen window of FIG. 6, the logo of KIA which pays for a small amount of an advertising fee is omitted among the logos displayed on the logo selecting screen window of FIG. 5 and a logo of KB* which pays for a large amount of an advertising fee is added thereon. Then, logos such as OB, SAMSUNG, H, SK, KT and KB* are automatically re-arranged on the display screen.

As described above, the logos selected according to an amount of an advertising fee are contained on a slot machine game screen by user's selection.

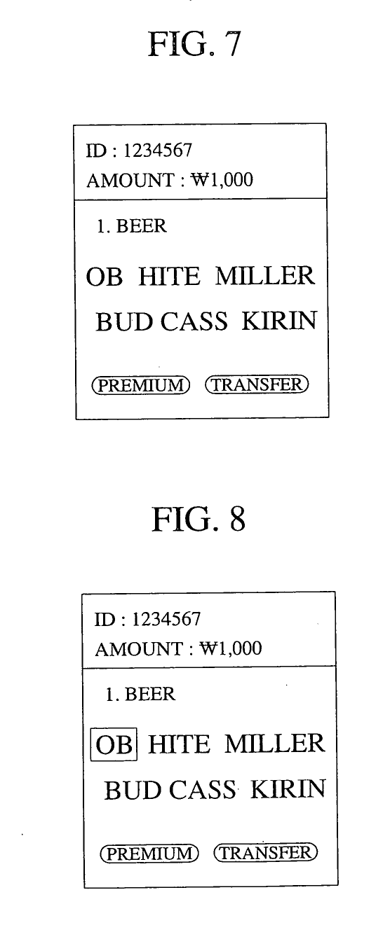

Also, in the case of a category type advertising screen, an ad display is prepared according to advertising contract conditions such as an advertising fee, frequency and position in an identical category, to thereby form an advertising screen, as shown in FIGS. 7 and 8.

FIGS. 7 and 8 are a view showing an example of a screen window showing an ad screen according to an advertising contract condition in an identical category, respectively. For example, an ad screen for beer among several categories can be constituted into OB, HITE, MILLER, BUD, CASS and KIRIN, according to the advertising contract condition. In particular, the logo of OB which is enclosed with a box in FIG. 8 indicates that an advertising logo to be used by a user in a slot machine game is selected as the logo of OB.

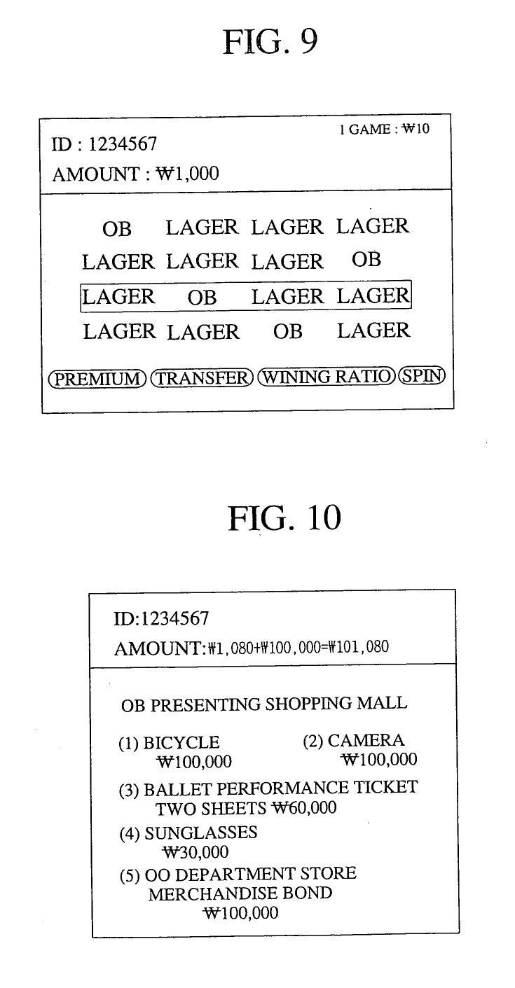

When a user selects an ad such as OB to be used in a game on a screen window of FIG. 8, the representative company ad logo and a main ad logo or image of the company product are mixed as shown in FIG. 9, where the company ad logo is OB and the product name is LAGER. Accordingly, the slot machine game server 130 constitutes an initial screen for a slot machine game.

FIG. 9 is a view showing an example of a start screen of a slot machine game. Here, a user can start playing a game by depressing a spin button at a game preparation state as if the user played a slot machine game in a casino. In this case, differently from a general slot machine game, a user's ID (ID: 1234567) and a cumulative amount of cyber money (AMOUNT: z,900 1,000) are always displayed on the slot machine game screen.

Also, a premium button is displayed on the screen so that a user can select a premium with cumulative cyber money. When the user depresses the premium button, a premium shopping mall 160 is accessed and displayed on the screen as shown in FIG. 10.

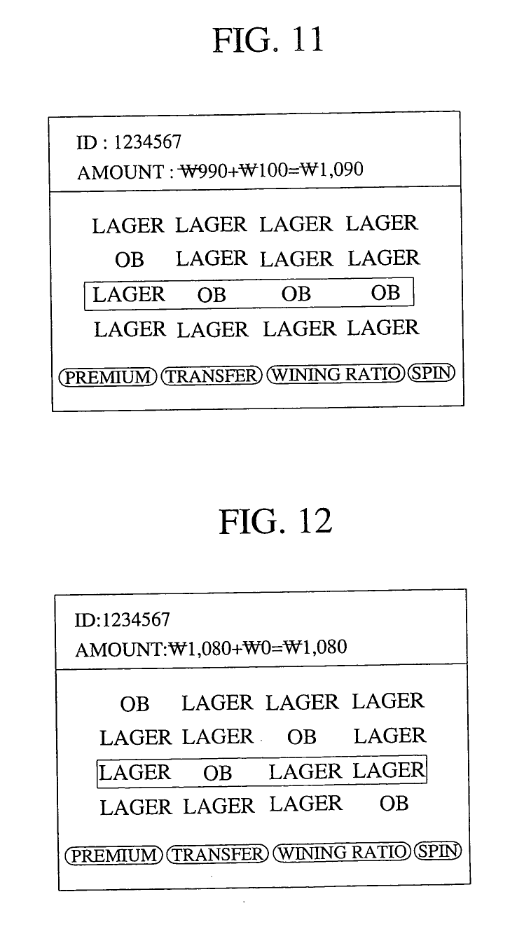

When a user depresses a spin button on a start screen of a slot machine game of FIG. 9, and then starts playing a game, a result of the game is decided at a winning ratio determined according to a slot machine game program, as shown in FIG. 11. Whenever each game is finished, a game cost is paid for. Here, initial cyber money can be provided free of charge at the time of registering a membership, or a certain amount of money can be purchased as a game cost.

FIG. 11 is a view showing an example of a slot machine game screen according to the present invention, in which z,900 990 indicated in the upper portion on the screen is an amount which is obtained by subtracting a game fee of z,900 10 from an initial cyber money of z,900 1,000. Here, z,900 100 indicates prize money determined by a game result, that is, a combination of logos “LAGER OB OB OB” which is indicated by the box enclosure, and z,900 1,090 is an amount of cumulating z,900 990 and z,900 100.

FIG. 12 is a view showing another example of a slot machine game screen according to the present invention. In FIG. 12, a game result is determined by a combination of logos “LAGER OB LAGER LAGER” which is enclosed by a box. As a result, prize money indicates z,900 0.

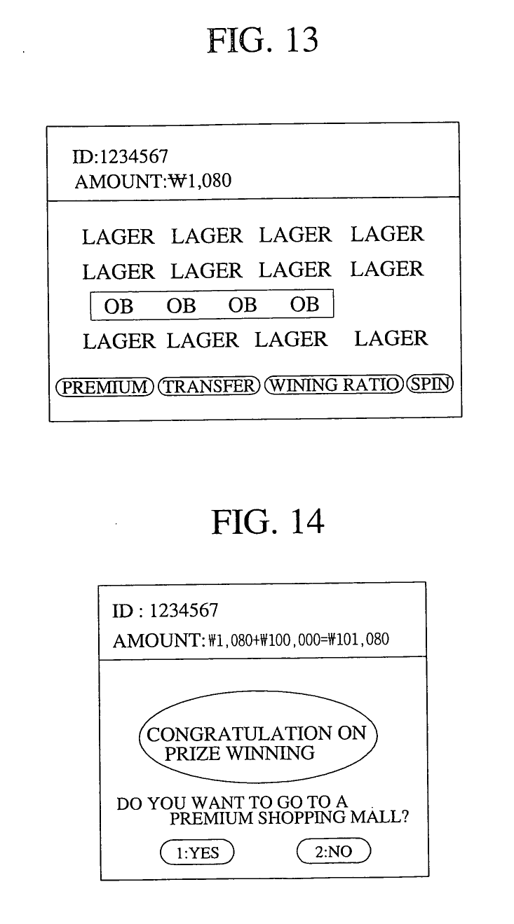

FIG. 13 is a view showing still another example of a slot machine game screen according to the present invention. FIG. 13 shows a result that a user who possesses an ID of 1234567 and cyber money of z,900 1,080 has played a slot machine game. The game result is determined as a combination of logos “OB OB OB OB” which is enclosed by a box, and indicates a case that the user won the first prize. That is, the first prize is determined when four of the representative ad logo “OB” are arranged and displayed in line.

FIG. 14 is a view showing an example of a congratulating message screen to be displayed in the case that a first prize winner is decided in FIG. 13. In FIG. 14, a message of “Congratulation! You won the first prize!” is displayed together with a prize winning congratulation fanfare. At the same time, prize money z,900 100,000 is cumulated in the cyber money amount in association with the cyber money settlement server 170, and is recorded in the customer management server 150, to then be displayed on the screen, as shown in FIG. 14. That is, the cumulated cyber money is recorded in the customer management server 150 and the cyber money settlement server 170 for settlement, and displayed on the screen.

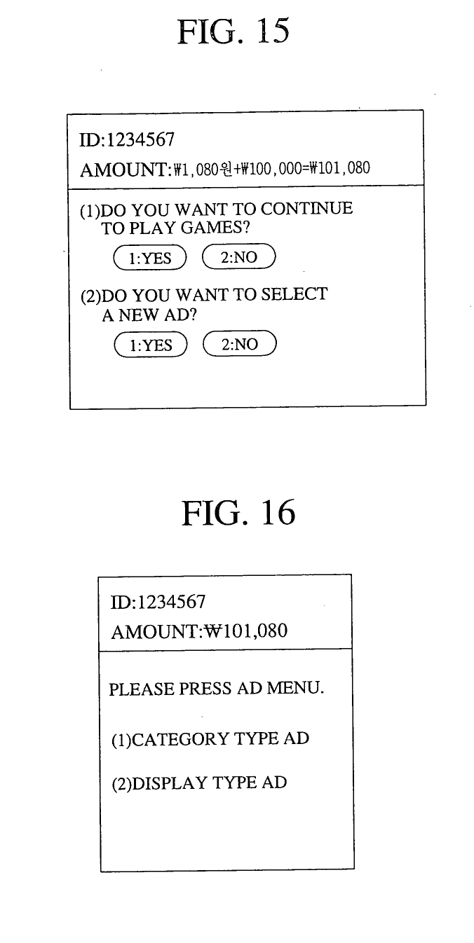

Then, if the user depresses a button of “YES” with respect to a question “Do you want to visit a premium shopping mall? in the FIG. 14 screen configuration, the slot machine game server 130 guides the user to the premium shopping mall 160 having the FIG. 10 screen configuration. Meanwhile, if the user depresses a button of “NO,” a screen window containing a question (1) asking the user whether or not the game will be continued (Do you want to continue to play the game?) and another question (2) asking the user whether or not a new ad will be selected (Do you want to select a new ad?), is displayed on the screen as shown in FIG. 15. Here, if the user selects the “YES” button with respect to the question (1) since he or she wants to continue to play the game, and then selects the “YES” button with respect to the question (2) of “Do you want to select a new ad?,” he or she can select a desired ad pattern between (1) a category type ad menu and (2) a display type ad menu with respect to a question of “Please depress a desired ad pattern.” as shown in FIG. 16.

Here, if the user has selected (1) the category type ad menu, the initial screen of FIG. 3 or 4 is displayed as described above, to thereby make the user select a desired item, while if the user has selected (2) the display type ad menu, the initial screen of FIG. 5 or 6 is displayed as described above, to thereby make the user select a desired ad logo.

Meanwhile, if the user selects the “NO” button with respect to the question (1) “Do you want to continue to play the game?” in the FIG. 15 screen, the game is finished.

Meanwhile, if the user selects the “YES” button with respect to the question (1) “Do you want to continue to play the game?” and selects the “NO” button with respect to the question (2) “Do you want to select a new ad? in the FIG. 15 screen, the current screen is shifted to the initially selected ad game screen of FIG. 9 which is the above-described game start screen.

Meanwhile, in the case that the user is guided to the premium shopping mall 160 by the user's selection, the user can see the FIG. 10 screen. Here, if the user selects cameras of an item (2) among (1) bicycles, (2) cameras, (3) ballet performance tickets, (4) sunglasses, and (5) “XX” department store merchandise bonds, in the premium shopping mall 160, a screen window containing messages “YOU HAVE PURCHASED A CAMERA AT z,900 100,000 A PIECE. DO YOU WANT TO RECEIVE A COALITION DEPARTMENT STORE MERCHANDISE BOND? DO YOU WANT TO RECEIVE A REAL CAMERA?” is displayed. Accordingly, the user can receive a merchandise bond with which a camera can be exchanged in the department store or a real product, according to his or her selection.

Here, in the case that the user selects the affiliated department store merchandise bond, the premium shopping mall 160 is associated with the merchandise bond/coupon/ticket system 180, and transmits a merchandise ticket to a user's cellular phone 60 registered in the customer management server 150 via the service provider server 20, by a SMS (short message service) transmission via the mobile telecommunications network 40. Accordingly, if the user depresses a “SAVE” button in his or her cellular phone as shown in FIG. 18, the merchandise bond is automatically stored in a certain memory in the cellular phone. Thereafter, the user can use the merchandise bond in relevant shops, using a LAN communications method which adopts bar code signals, infrared ray signals, radio frequency signals, or Bluetooth signals, or directly showing the merchandise bond displayed on the cellular phone screen to a clerk.

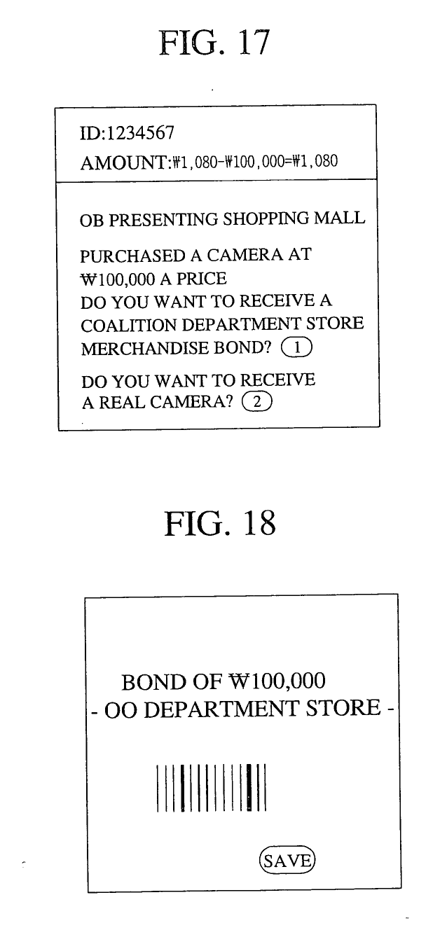

Meanwhile, if the user selects that he or she wants to receive the real product of the item (2), with respect to the questions containing messages “YOU HAVE PURCHASED A CAMERA AT z,900 100,000 A PIECE. (1) DO YOU WANT TO RECEIVE A COALITION DEPARTMENT STORE MERCHANDISE BOND? (2) DO YOU WANT TO RECEIVE A REAL CAMERA?” in the FIG. 17 screen window, an address at which the real product will be delivered is confirmed, and then a delivery processing is processed by the delivery system 210.

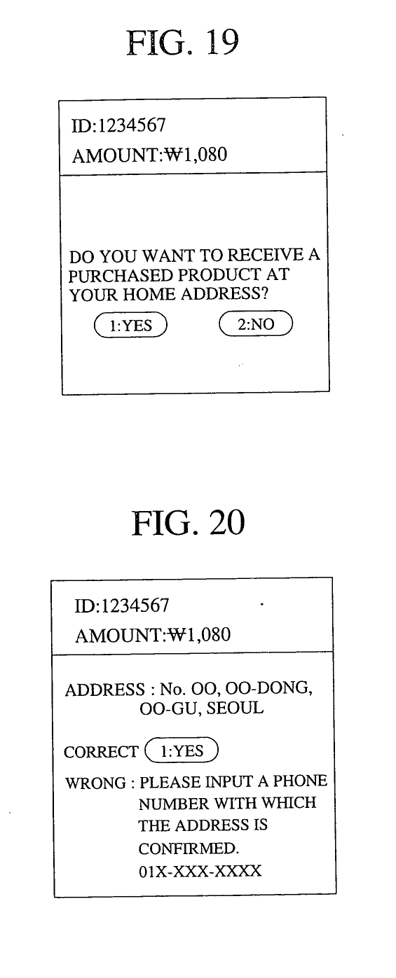

The address confirmation process follows. First, as shown in FIG. 19, if the user selects a “YES” button of buttons of (1) “YES” and (2) “NO” with respect to a question “DO YOU WANT TO RECEIVE A PURCHASED PRODUCT AT YOUR HOME ADDRESS?,” a screen window where the user's address is displayed is output as shown in FIG. 20. Accordingly, if the address is correct, the user depresses the “YES” button, while if the address is wrong, the user inputs his or her cellular phone number according to a message “PLEASE INPUT A PHONE NUMBER WITH WHICH THE ADDRESS IS CONFIRMED.”

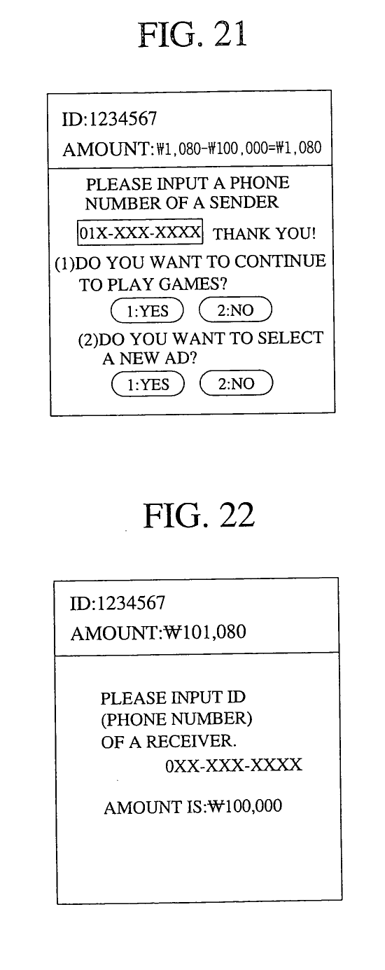

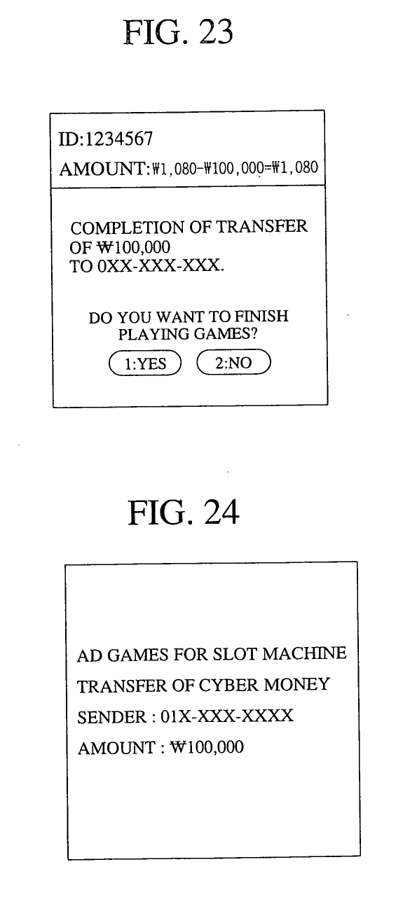

Here, since the user wants the selected product “camera” to the other person, and if the user selects the “NO” button of (2) “NO” with respect to a question “DO YOU WANT TO RECEIVE A PURCHASED PRODUCT AT YOUR HOME ADDRESS?” of the FIG. 19 screen window, the user inputs a phone number of the person for whom the user wants to present the camera according to a message “PLEASE INPUT A PHONE NUMBER OF A RECEIVER.” as shown in FIG. 21. Accordingly, the input phone number is sent to the customer management center (call center) 220. The call center 220 calls a person who receives the present with the input phone number and confirms the address and stores the confirmed address, to then be automatically connected to the delivery system 210 to perform a delivery processing.

Also, the cyber money which is obtained through games by the user can be transferred to the other user. That is, in the above-described FIG. 3 screen configuration, if the user selects a transfer button, the user's terminal is connected to the cyber money settlement server 170, the customer management server 150, and the cyber money transfer server 230, in sequence, and the user inputs a phone number “0XX-XXX-XXXX” of a person who receives transferred cyber money according to a message “PLEASE INPUT ID (PHONE NUMBER) OF A RECEIVER.” as shown in the FIG. 22 screen window. Then, if the user inputs an amount of for example, z,900 100,000, the cyber money is automatically transferred to the ID or phone number of the receiver.

Then, when a question window containing messages “COMPLETION OF TRANSFER OF z,900 100,000 TO 0XX-XXX-XXX. DO YOU WANT TO FINISH PLAYING GAMES?” is output, the user selects whether or not the game will be finished.

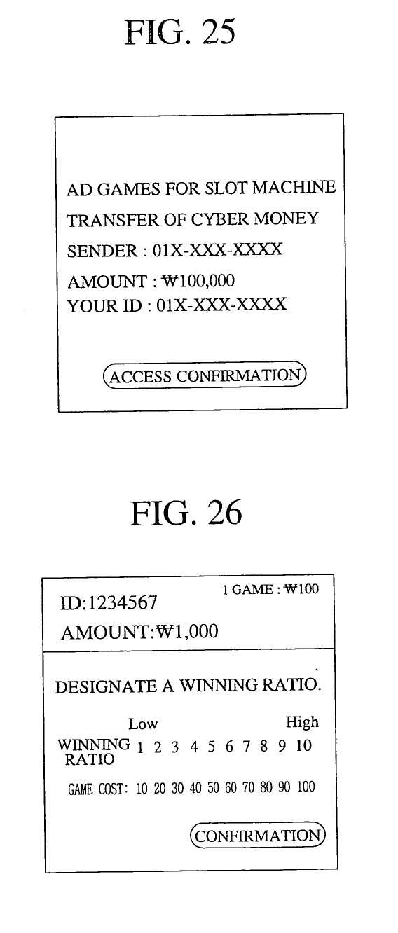

Here, the service provider server 20 notifies the cellular phone of the transferee of the transfer information via a SMS function containing messages “AD GAMES FOR SLOT MACHINE, TRANSFER OF CYBER MONEY, SENDER, AMOUNT z,900 100,000” as shown in FIG. 24. In the case that the transferee is not an existing member, the cellular phone number of the transferee is automatically recognized as an ID, and a new member registration procedure is processed in the customer management server 150. Then, as shown in FIG. 25, the new registration information is notified of the transferee together with a SMS message containing “AD GAMES FOR SLOT MACHINE, TRANSFER OF CYBER MONEY, SENDER, AMOUNT z,900 100,000, YOUR ID: 0XX-XXX-XXXX.” Then, if the new registered user depresses a “access conformation” button and accesses the customer management server 150 to thereby enable the user to enter his or her customer information additionally.

Also, the slot machine game provided in the present invention enables a user to select his or her desired winning ratio, to thereby heighten a user's option. For example, a winning ratio scale can range between ten grades from HIGH:10 to LOW:1, to thereby enable a user to select a desired winning ratio. As shown on the FIG. 9 game start screen, the winning ratio button is selected to select a winning ratio. A user can select a desired winning ratio all the time before playing games or during playing games. If the user does not select a winning ratio, a slot machine game proceeds according to a winning ratio determined as default.

The game start screen displayed in FIG. 9 shows that cyber money of z,900 10 per game is subtracted from the possessed cyber money as a game fee determined according to a default winning ratio. If the user depresses a winning button on the screen window, the winning ratio selecting server 140 is accessed, and thus a screen window of FIG. 26 is output. That is, as shown in FIG. 26, in the case that the user determines a winning ratio as HIGH:10, a game fee of z,900 100 corresponding to a winning ratio of HIGH:10 is automatically indicated in a box. Accordingly, a message “One game: z,900 100” is automatically displayed on the screen.

Here, if the user depresses a confirmation button, the current screen is connected again to the game start screen shown in FIG. 9, so that the user can play the game at a cyber money cost of z,900 100 per game. Here, assuming that a winning ratio of LOW:1 is X, the winning ratio of HIGH:10 becomes X multiplied by ten. According to a winning ratio determination method of the present invention as described above, prize winning money is fixed and a winning ratio is freely determined. Accordingly, the present invention enables users to play a new type game which charges the users depending upon a winning ratio.

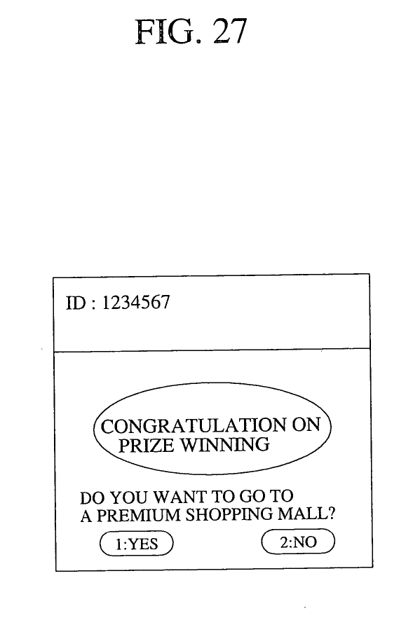

Also, the slot machine game according to the present invention enables users not to feel burdens for cyber money but to enjoy playing only the game so that they faithfully watch advertisements displayed on the screen. As illustrated in FIG. 27, users can receive a premium such as merchandise bond/coupon/ticket according to a game result although the other conditions are same.

As described above, the slot machine game according to the present invention enables a user to access the service provider server 20 via the user computer 50 or the cellular phone 60 and enjoy a slot machine game using image ad symbols on an on-line connection basis. In particular, if a user plays a slot machine game using the cellular phone 60, a wireless Internet communication fee is excessively charged to make the user feel much burden. Accordingly, as a method of reducing a communication fee, a user selects a particular advertising image at the state where the user accesses the service provider server 20, and downloads the selected advertising image and an ad game program, to thereby make the user play the downloaded game. In this case, the user plays the game at the state where the user does not access the service provider server 20. Here, the user can access the service provider server 20 only if he or she obtains a certain point or won a premium, or wants to charge cyber money. As a result, a communication fee can be reduced in comparison with the case of playing the game on an online basis.

The slot machine game server communicates bidirectionally with the user terminal during providing a slot machine game service, and provides a question-to-answer ad quiz. That is, it is possible to adopt a bidirectional question-to-answer ad quiz system that a question related with ads is given during playing a slot machine ad game, so that a user answers the question. When the above-described bidirectional question-to-answer ad quiz system is applied, users can avoid participating in the game mechanically and participate in the game faithfully, to thereby heighten an ad recognition degree. For example, in the case of a game advertising a brand of “LAGER” of OB beer company, a question “What is a new brand of OB?” is given to a user after playing a slot machine game several tens of times. Only if the user answer that it is “LAGER,” the game proceeds again otherwise, the game is stopped. Also, after playing the game more than a certain number of times, a question “What is pungent beer for youngsters?” is given so that the user answers it as “LAGER,” to thereby enhance an advertising effect.

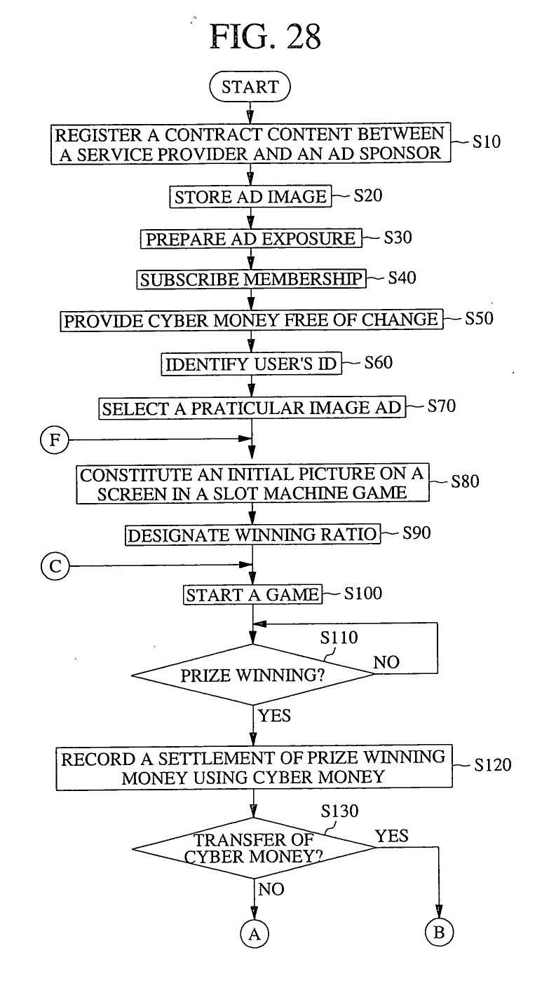

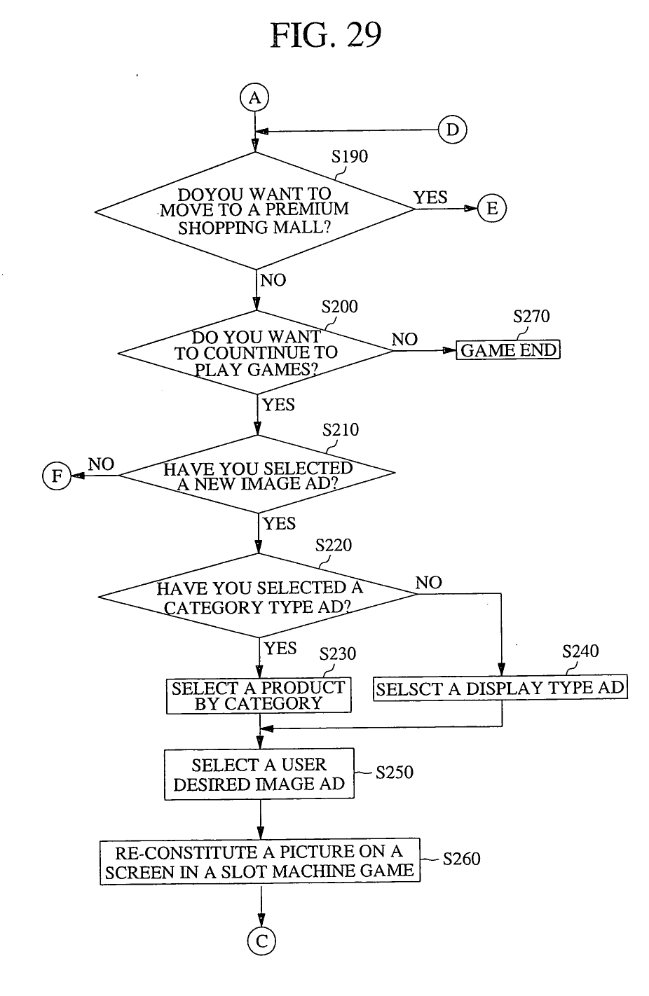

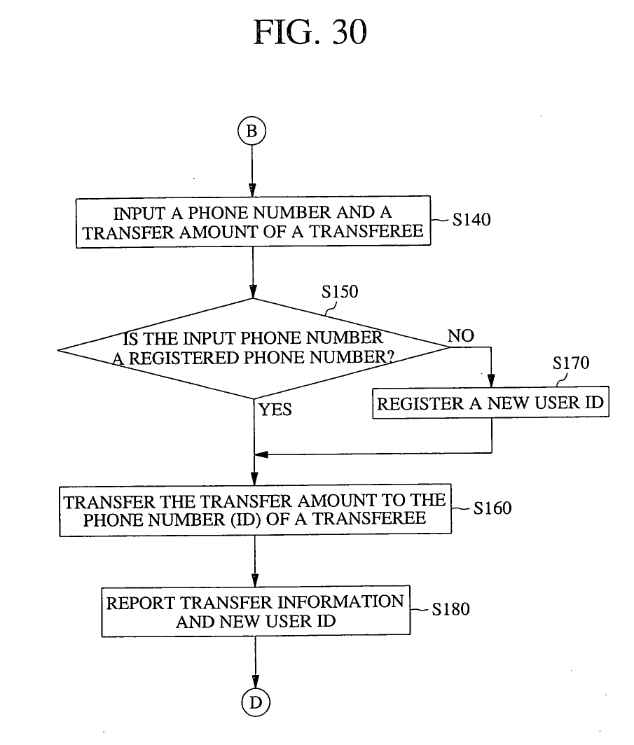

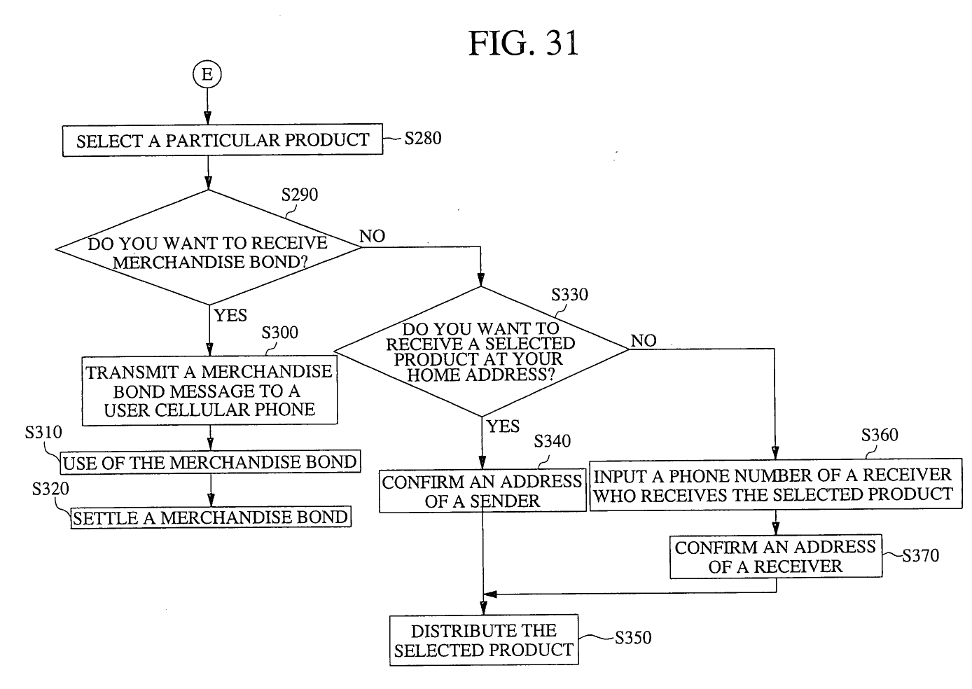

An advertising method in an Internet advertising system for a slot machine game having the above-described configuration according to the present invention will be described in detail with reference to FIGS. 28 through 31.

FIGS. 28 through 31 are flow chart views illustrating processes of an Internet advertising method for a slot machine game using image advertising symbols according to an embodiment of the present invention.

As illustrated, a service provider completes an advertising contract with an advertising agency or an advertising sponsor in order to provide an ad service, and registers the advertising contract content in the service provider server 20 (S10). If the service provider receives an advertising image from the advertising sponsor to then be stored in the service provider server 20 (S20), the ad generating server 110 prepares an exposure of an ad on a category type screen or a display type screen of ads, in association with the category type ad generating server 111, the ad exposure frequency/positioning server 112, and the display type ad generating server 113 which are all the lower-part system of the ad generating server 110, according to advertising contract conditions such as an advertising fee, a frequency of exposing ads, and an exposure position on a screen, which are registered in the service provider server 20 (S30).

Then, the user accesses the service provider server 20 via the user computer 50 in order to use a slot machine ad game according to the present invention, and undergoes a simple member registration procedure to receive a specific ID (S40). Here, the user phone number can be used as an ID.

Here, the user receives a certain amount of cyber money free of charge, which enables the user to play the game, when he or she registers as a member in the service provider server 20 (S50). Also, the user can purchase cyber money through a telephone fee charging method or other settlement methods.

Then, the user undergoes an authentication of the ID assigned from the service provider server 20 (S60), and then uses a slot machine game service according to the present invention. Here, when the user accesses the server using his or her cellular phone as an ID, the server can recognize the cellular phone number automatically. Accordingly, the user need not input the user's ID separately.

Also, when the ad exposure preparation is completed in step S30, the user selects a particular image ad which is used for the slot machine ad game among the image ads provided from the ad generating server 110 (S70).

Accordingly, the ad generating server 120 mixes the particular image ad selected by the user, that is, the representative ad logo and a main ad logo or image of the particular company, where the company ad logo is OB and the product name is LAGER, to thus constitute an initial screen for a slot machine game (S80), in association with the slot machine game server 130.

Also, a user selects his or her desired winning ratio, from a winning ratio scale ranging between ten grades from HIGH:10 to LOW:1 (S90). The user can select a desired winning ratio all the time before playing games or during playing games. If the user does not select a winning ratio, a slot machine game proceeds according to a winning ratio determined as default.

If a winning ratio is determined by a user as described above, a game proceeds at a game cost corresponding to the determined winning ratio. That is, the user can start playing a game by depressing a spin button displayed on the screen as if the user played a slot machine game in a casino (S100).

When the user depresses the spin button on a start screen of a slot machine game, and then starts playing a game, a result of the game is decided at a winning ratio determined according to a slot machine game program. Whenever each game is finished, a game cost is paid for.

Thereafter, it is confirmed whether or not prize winning occurs according to a game result (S10). If a prize winner is decided, in particular, a first prize winner is decided, a message of “Congratulation! You won the first prize!” is displayed on the screen together with a prize winning congratulation fanfare. At the same time, a cumulated amount of cyber money added with prize money is settled and recorded in the customer management server 150 and the cyber money settlement server 170 (S120), and is displayed on the screen.

Also, the user can decide whether or not cyber money will be transferred to the other user (S130). If the user intends to present the cyber money which is obtained through games to the other user, that is, if the user selects a transfer button, the user's terminal is connected to the cyber money settlement server 170, the customer management server 150, and the cyber money transfer server 230, in sequence, and the user inputs a phone number of a person who receives transferred cyber money according to a message “PLEASE INPUT ID (PHONE NUMBER) OF A RECEIVER” and then inputs an amount of the cyber money to be transferred (S140).

In this case, the service provider server 20 checks if the phone number input in step S140 is a phone number registered in a database (S150). If the input phone number is a registered phone number, the cyber money to be transferred is automatically transferred to the phone number (or ID) of the person to receive the cyber money to be transferred (S160). However, if the input phone number is not a registered phone number, the phone number of the person who receives the cyber money to be transferred is regarded as an ID and thus a new user registration procedure is automatically accomplished in the customer management server 150 (S170). Then, the cyber money to be transferred is automatically transferred to the newly registered phone number.

Here, the service provider server 20 notifies the cellular phone of the transferee of the transfer information and the new user information via a SMS function containing messages “AD GAMES FOR SLOT MACHINE, TRANSFER OF CYBER MONEY, SENDER: 01X-XXX-XXX, AMOUNT z,900 100,000, YOUR ID: 0XX-XXX-XXXX” (S180).

Meanwhile, in the case that the user does not want to transfer the cyber money in step S130 where it is decided whether or not cyber money will be transferred, the user decides whether or not the current screen will be shifted to the premium shopping mall 160 (S190). Here, if the user moves to the premium shopping mall 160, he or she can select a particular product, for example, a camera in the premium shopping mall 160 (S280).

Here, the user determines whether or not he or she will receive his or her selected product as an affiliated department store merchandise bond (S290). In the case that the user wants to receive the selected product as the affiliated department store merchandise bond, the premium shopping mall 160 is associated with the merchandise bond/coupon/ticket system 180, and transmits a merchandise ticket to a user's cellular phone 60 registered in the customer management server 150 via the service provider server 20, by a SMS (short message service) transmission via the mobile telecommunications network 40 (S300). Accordingly, if the user depresses a “SAVE” button in his or her cellular phone, the merchandise bond is automatically stored in a certain memory in the cellular phone. Thereafter, the user can use the merchandise bond in relevant shops, using a LAN communications method which adopts bar code signals, infrared ray signals, radio frequency signals, or Bluetooth signals, or directly showing the merchandise bond displayed on the cellular phone screen to a clerk (S310). The merchandise bonds which have been used in the shops are settled by the merchandise bond/coupon/ticket settlement server 200 which is connected to the shops (S320).

Meanwhile, if the user wants to receive the real product instead of an affiliated department store merchandise bond, in a process of determining whether or not his or her selected product will be received as an affiliated department store merchandise bond, an address at which the real product will be delivered is confirmed (S330). Here, if the user wants to receive the selected product at his or her home address, it is confirmed whether or not an address to be displayed on the screen is correct (S340). Then a delivery processing is processed by the delivery system 210 (S350).

If the user wants the selected product to the other person, in a process of determining whether the selected product will be delivered to his or her home address (S330), the user inputs a phone number of the person who receives the product (S360), the call center 220 calls the person who receives the present with the input phone number and confirms the address (S370), and stores the confirmed address, to then enable the delivery system 210 to automatically perform a delivery processing.

Meanwhile, if the user does not want to move to the premium shopping mall 160 in a process of determining whether or not the user will move to the premium shopping mall 160 (S190), the user determines whether he or she will continue to play the game (S200). If the user has determined to continue to play the game, it is determined whether or not a new image ad will be selected (S210). Here, in the case that the user wants to select a new image ad, it is determined whether a category type ad will be selected (S220). Then, a category type item which is displayed on the screen is selected (S230), or a display type ad is selected (S240).

Then, if the user selects a desired image ad between a category type or display type ad pattern (S250), the screen of the slot machine game is re-configured, to thus make the user start to play the game again.

However, if the user does not want to play the game any more in a process of determining whether or not the user will continue to play the game, a game end indication screen is displayed while making the game completed (S270).

Also, if the user does not want to select a new image ad in a process of determining whether or not the new image ad will be selected (S210), the current screen is shifted to the ad game screen which was initially selected by the user.

As described above, the present invention can provide a slot machine game on the Internet, in which display symbols such as Watermelon, BAR, and 777 are replaced by image advertising symbols. As a result, a variety of ad information is consistently provided to users who enjoy playing a slot machine game, to thereby maximize an ad effect.

1. An Internet advertising system using image advertising symbols for use in a slot machine game, the Internet advertising system comprising:
a service provider server which stores and manages advertising symbols transmitted from a number of advertising sponsors according to different advertising contract conditions;
an advertisement (or ad) generating server which generates advertising images from the advertising symbols provided from the service provider server;
an ad selecting server which mixes an advertising image selected by a user among the various kinds of ads produced from the ad generating server;
a slot machine game server which constitutes the advertising images mixed by the ad selecting server into a display screen of a slot machine game; and
a user terminal with which the user registers for the service provider server as a member via the Internet and then receives a slot machine game service provided from the slot machine game server.

2. The Internet advertising system of claim 1, wherein said ad generating server comprises:
a category type ad generating server which classifies the advertising symbols provided from the service provider server according to the advertising content by category and generates advertising images;
an ad exposure frequency/positioning server which designates an exposure frequency and position of an advertising image according to an ad contract condition with the ad sponsor; and
a display type ad generating server which generates advertising images according to the exposure frequency and position determined by the ad exposure frequency/positioning server.

3. The Internet advertising system of claim 1, further comprising a winning ratio selecting server which enables the user to determine the winning ratio of the game at his or her desired degree during using a slot machine game service.

4. The Internet advertising system of claim 1, wherein said service provider server provides a certain amount of cyber money to the user free of charge when he or she registers as a member.

5. The Internet advertising system of claim 4, further comprising a customer management server which manages membership information and cyber money of the users.

6. The Internet advertising system of claim 1, wherein said service provider server pays a certain amount of cyber money to the user when the user won the prize in the result of using the slot machine game service.

7. The Internet advertising system of claim 6, further comprising a cyber money transfer server which can transfer the cyber money received from the service provider server to the other user.

8. The Internet advertising system of claim 6, further comprising a premium shopping mall which enables the user to select and receive a premium with cumulated cyber money received from the service provider server.

9. The Internet advertising system of claim 8, further comprising a cyber money settlement server which settles the cyber money obtained in the result of playing the slot machine game and that used in the premium shopping mall.

10. The Internet advertising system of claim 1, wherein the user terminal downloads a particular advertising image and an ad game program provided through the service provider server on the Internet, so that the user can use a slot machine game service on an off-line basis.

11. The Internet advertising system of claim 10, wherein the user accesses the service provider server in the case that the user obtains certain marks during using the slot machine game service on an off-line basis.

12. The Internet advertising system of claim 10, wherein the user accesses the service provider server in the case that the user won a premium prize during using the slot machine game service on an off-line basis.

13. The Internet advertising system of claim 10, wherein the user accesses the service provider server in the case that the user wants to charge cyber money during using the slot machine game service on an off-line basis.

14. The Internet advertising system of claim 1, wherein the slot machine game server communicates with the user terminal bidirectionally and provides a question-to-answer ad quiz to the user.

15. An Internet advertising method using image advertising symbols for use in a slot machine game, the Internet advertising method comprising the steps of:
(a) generating various kinds of advertising images according to different advertising contract conditions with respect to advertising sponsors and storing the same in a service provider server;
(b) a user accessing the service provider server via the Internet and selecting a particular advertising image to be used for a slot machine game among the various kinds of displayed advertising images;
(c) mixing the particular advertising image selected by the user in an advertisement (or ad) selecting server and constituting the advertising image into an initial screen of the slot machine game; and
(d) the user depressing a spin button displayed on the initial screen of the slot machine game and starting to play the slot machine game.

16. The Internet advertising method of claim 15, wherein the initial screen of the slot machine game is configured by mixing a representative ad image and a main ad image of a particular company by the ad selecting server.

17. The Internet advertising method of claim 15, further comprising the step of determining a winning ratio of the game at the user's selection, before starting the slot machine game or during playing the slot machine game.

18. The Internet advertising method of claim 15, further comprising the step of giving a certain amount of cyber money to the user to then be settled and recorded in the case that the user won the slot machine game.

19. The Internet advertising method of claim 18, further comprising the step of inputting an ID of the other user who receives transfer money and an amount of transfer money, to then enable the transfer money to be automatically transferred to the other user, in the case that the user determines to transfer the cyber money to the other user after a certain amount of cyber money is given to the user to then be settled and recorded.

20. The Internet advertising method of claim 19, further comprising the step of selecting a particular product in the premium shopping mall, in the case that the user does not transfer the cyber money to the other user but determines whether or not the current screen is shifted to a premium shopping mall website which enables the user to purchase a premium with the cyber money and accesses the premium shopping mall website.

21. The Internet advertising method of claim 20, further comprising the steps of receiving an information message for the merchandise bond in the cellular phone via a mobile communications network, in the case that the user has selected the particular product and determines whether the user will receive a merchandise bond with which the particular product can be purchased, with a result that the user determines to receive the merchandise bond; and receiving the particular product by a wireless communications network method with a POS terminal in a shop which enables the user to purchase the particular product.

22. The Internet advertising method of claim 21, further comprising the steps of automatically delivering the real product to an address of the user in which the address of the user to be pre-stored and displayed on the screen is confirmed in the case that the user does not want the particular product as the merchandise bond but as the real product.

23. The Internet advertising method of claim 20, further comprising the steps of re-configuring the screen of the slot machine game in the case that it is determined whether or not a new advertising image will be selected to thus determine that a new ad image is selected when the user does not move to the premium shopping mall website but plays the game consistently.

24. The Internet advertising method of claim 23, further comprising the steps of re-starting the game with the initial screen configuration of the slot machine game in the case that the user does not select the new ad image but plays the game consistently.
